(19) United States
(12) Patent Application Publication
(10) Pub. No.: US 2017/0161903 A1
(43) Pub. Date: Jun. 8, 2017

(54) METHOD AND APPARATUS FOR GESTURE RECOGNITION

(71) Applicant: Calay Venture S.á r.l., Bettembourg (LU)

(72) Inventor: Cevat Yerli, Frankfurt am Main (DE)

(73) Assignee: Calay Venture S.á r.l., Bettembourg (LU)

(21) Appl. No.: 14/958,609

(22) Filed: Dec. 3, 2015

(51) Int. Cl. G06T 7/00; G06T 19/20; G06K 9/00; G06F 3/01

(52) U.S. Cl. CPC G06T 7/0046; G06F 3/017; G06T 19/20; G06K 9/00355

(57) ABSTRACT

A computer-implemented method and an apparatus for improving gesture recognition are described. The method comprises providing a reference model defined by a joint structure, receiving at least one image of a user, and mapping the reference model to the at least one image of the user, thereby connecting the user to the reference model for recognition of a set of gestures predefined for the reference model, when the gestures are performed by the user.

### TECHNICAL FIELD

The present disclosure relates to a method and an apparatus for gesture recognition and, in particular, to three-dimensional (3D) gesture recognition that may allow 3D gesturing to control devices using a set of predefined motion data.

### BACKGROUND

Computer devices are increasingly controlled by interfaces without relying on a keyboard or a mouse. For example, the concept of gesture recognition is used in various applications and has gained increased interest recently. Cameras, computer vision systems, and algorithms are used in systems to translate gestures into something a device can interpret to initiate an action associated with the corresponding gesture. However, the quality of recognition in these systems still needs to be improved to avoid misinterpretations resulting in false actions of computer devices. Since computer devices provide typically a prompt response upon detection of gestures, a false detection is in many situations not acceptable.

Therefore, there is a demand for improving gesture recognition.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The present disclosure solves the above problems by providing a method, an apparatus, and a computer-readable medium according to the independent claims. The dependent claims refer to specifically advantageous realizations of the subject matter of the independent claims.

The present disclosure defines a method, in particular a computer-implemented method, for improving gesture recognition, e.g., of a set of predefined gestures, based on at least one image of a user. The method comprises the acts of providing a reference model defined by a joint structure, receiving at least one image of a user, and mapping the reference model to the at least one image of the user, thereby connecting the user to the reference model for recognition of a set of gestures predefined for the reference model, when the gestures are performed by the user.

The image of the user may be an image depicting the whole user or at least a part of the user's body, e.g., a user's hand or an upper body part. The reference model may be defined by a joint structure representing, for example, a user (or a part of the user's body such as a hand) with bones and joints, such as fingers, and a surface structure, such as a skin structure. Reference models are common in computer animations and the reference model used in the present disclosure can be identical or similar to skeleton models used by developers in the creation of animated meshes for avatars or characters in computer games. Hence, the reference model may include a hierarchical structure of joints, wherein each joint may be rotated and/or translated, and which may influence subsequent joints of the hierarchical structure.

The step of providing the reference model may include a step of reading or receiving the data defining the reference model from a memory of a (local or remote) computer device.

In the following, major aspects of the present disclosure will be described in terms of hand gestures and a reference hand model. However, a person skilled in the art will readily appreciate that this should not limit the present disclosure. Rather, any part(s) of a human body can be used to define gestures and should be covered by the present disclosure. Therefore, whenever features are described using a user's hand or a hand model such features can be replaced by the user's body and a body model (or any part of the body).

The step of connecting the exemplary user's hand to the reference hand model may include an adaptation of the set of predefined gestures based on the mapping to define a personalized set of gestures for the user's hand. However, it is not necessarily needed to adapt or modify the predefined gestures. For example, as long as a mapping transformation of a pre-stored reference hand model to the actual user's hand is known, a system may transform a captured hand or a captured gesture to the reference model and compare the captured gesture with the pre-stored gestures in order to determine an action associated with the gestures. Thus, according to another embodiment, the step of mapping comprises an adjustment of relative positions of the joints of the reference model, thereby adapting a shape of the reference hand model to the user's hand.

The above-mentioned problem is solved by enabling the system to personalize the set of predefined gestures so that the system does not need to tolerate natural fluctuations in shape, size, etc., of human bodies—at least to a lesser extent. By personalizing the gestures to the particular user the system is thus able to easily distinguish between different gestures. Hence, embodiments of the present disclosure greatly improve gesture recognition.

Gestures may be defined statically as a particular shape, arrangement, or orientation, or dynamically as a particular motion of the exemplary hand (or the reference hand model). Thus, gestures can be defined by (relative) positional and/or orientational data, or by data of the predetermined positions and/orientations in the 3D space. Similarly, markers may also be defined using three coordinates so that markers may define locations and/or orientations in 3D space. It is to be understood that the predetermined positions may include any number of positions. Preferably, the number is large enough to define the gestures uniquely (without misinterpretation).

Thus, according to embodiments, the provided reference model defines a three-dimensional model of at least a part of a human and the joints may define points through which at least one rotational axis of a human movement passes.

According to another embodiment, the method further comprises capturing at least one image of the user, wherein the image is a three-dimensional image, an image including depth information, or at least two (2D) images from different perspectives.

According to yet another embodiment, the method further comprises analyzing the at least one image of the user to enable a comparison with the reference model, wherein analyzing comprises identifying joint positions in the captured images, e.g., identifying joints of a user's hand. This may be achieved by identifying characteristic structures and/or patterns in the image that may be associated with joints and/or markers of the reference model.

According to yet another embodiment, the method further comprises identifying virtual markers placed on the user's hand wherein the mapping is based on the virtual markers. This may improve and accelerate the mapping.

According to another embodiment, the method further comprises storing the results of the mapping in a storage, such as a memory or a database. The storage may be part of a local computing system, but may also be part of a remote server connected to the local computing system by a network connection.

According to yet another embodiment, the method further comprises capturing at least one image depicting a gesture of the user, recognizing in the captured image one of predetermined gestures based on the results of the mapping or the mapped reference model, and initiating a predefined action associated with the recognized gesture. The captured at least one image may comprise a three-dimensional image that includes depth information. However, the captured at least one image may also comprise at least two two-dimensional images taken from different perspectives in order to enable the system to obtain three-dimensional information from the two two-dimensional images.

Thus, a system or computing device performing the method may use the mapping or the mapped reference model to generate personalized gestures, which are compared with the captured gesture to identify the associated action.

Since the mapping is user-specific, it may also be used for identifications. Hence, according to yet another embodiment, the method further comprises identifying the user based on the mapping, preferably after the system has stored the results of the mapping, e.g., if the user performs a subsequent specific gesture, which may be predefined for this purpose.

According to yet another embodiment, the predefined gestures include at least one of the following: pinching a thumb and a forefinger, un-pinching the thumb and the forefinger, making a clenched fist, unmaking a clenched fist. The associated actions may comprise: increasing/lowering the volume of an audio device, the brightness, contrast, etc., of a display device, and the like, closing or opening of applications, moving windows, etc. For example, any action that can be initiated using a computer mouse or a touch screen may also be triggered by recognized gestures.

According to one aspect of the present disclosure, an apparatus for gesture recognition, e.g., recognition of a set of predefined gestures based on at least one image of a user, comprises a (non-volatile) memory configured to store and provide a reference model defined by a joint structure, an input interface configured to receive at least one image of a user, and at least one logic configured to map the reference model to the at least one image of the user, thereby connecting the user to the reference model, for recognition of a set of gestures predefined for the reference model, when the gestures are performed by the user. The at least one logic may be a processor or processor core implemented in hardware (i.e., not a virtual processor implemented in software).

The at least one image and/or the reference model may be stored (as result of previous acts) in the memory from which the logic can retrieve them. According to further embodiments, the reference model and/or the image of the user may also be stored remotely. In this case, the apparatus may use an optional network interface to retrieve the reference model and/or the image of the user from the remote computing device. However, also in this case, when receiving the reference model it may be first stored in the memory before processing it in the logic acting as processing unit. Again, gestures can be stored in a database as static positional and/or orientational data or as dynamic motion data.

According to another embodiment, the at least one logic is further configured to adjust relative positions of joints of the reference model thereby adapting a shape of the reference model to the user.

According to yet another embodiment, the apparatus may further comprise at least one image capturing device (e.g., a camera) configured to capture the at least one image of the user, wherein the at least one image of the user comprises a three-dimensional image or at least two images from different perspectives.

According to yet another embodiment, the at least one capturing device is further configured to capture at least one image depicting a gesture of the user, and the logic is further configured to recognize in the at least one captured image one of predefined gestures based on the results of the mapping or the mapped reference model. Subsequently, a predefined action associated with the recognized gesture may be initiated.

According to yet another embodiment, the apparatus may further comprise a comparator configured to compare the at least one image of the user with the reference model to identify the joint positions in the captured images, e.g., positions of joints of a captured user's hand.

According to yet another embodiment, the at least one logic is further configured to store the results of the mapping in a memory, such as in a database.

According to yet another embodiment, the at least one logic is further configured to identify the user based on the mapping after the system has stored the results of the mapping.

The defined methods may also be implemented in software as a computer program product or a computer-readable tangible medium and the order of the defined steps may not be important to achieve the desired effect. Thus, the present disclosure may relate also to a computer program product having a program code stored thereon for performing the above-mentioned method, when the computer program is executed on a computer or processor, or to a tangible medium having instruction stored thereon that when executed on a computer or a processor cause the computer or processor to perform the method.

According to yet another aspect a computing device includes a capturing device and a processor, wherein the processor is configured to recognize a predefined gesture based on a mapped reference model, wherein the mapped reference model is generated according one or more embodiments of the present disclosure.

In addition, all functions described previously in conjunction with the apparatus or computing device can be realized as further method steps and be implemented in software or software modules.

### BRIEF DESCRIPTION OF THE DRAWINGS

Various embodiments of the present disclosure will be described in the following by way of examples only, and with respect to the accompanying drawings, in which:

FIG. 1 depicts a flowchart for a method for gesture recognition according to an embodiment of the present disclosure;

FIG. 2 depicts an exemplary reference hand model;

FIGS. 3A and B depict a depth camera hand image and a video camera hand image;

FIG. 4 depicts a system flowchart with respective components; and

FIG. 5 depicts an exemplary apparatus for improving gesture recognition according to embodiments of the present disclosure.

### DETAILED DESCRIPTION

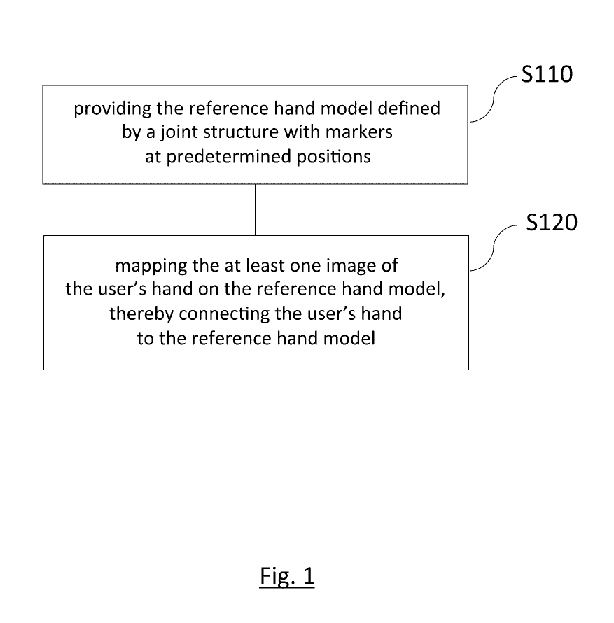

FIG. 1 depicts a flowchart for an embodiment of the method for improving gesture recognition based on at least one image of a user (e.g., a user's hand). The method comprises: providing S110 a reference model (e.g., a hand model) defined by a joint structure with joints and/or markers at predetermined positions; and mapping S120 the at least one image of the user on the reference model, thereby connecting the user to the reference model to improve a recognition of a set of gestures defined for the reference model, when the gestures are performed by the user.

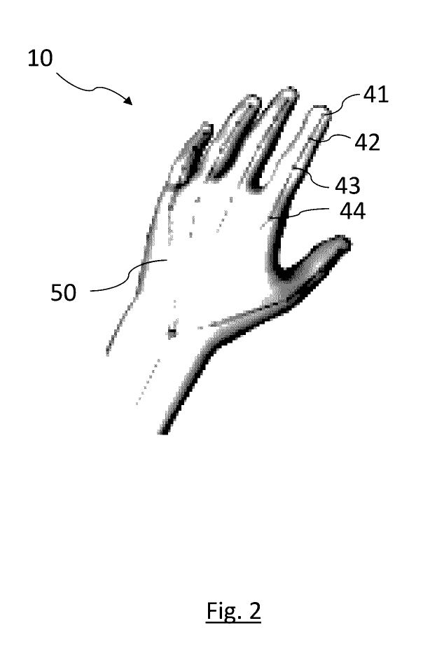

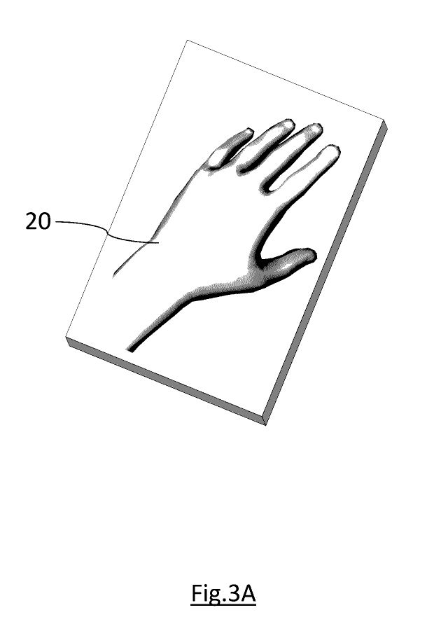

FIG. 2 depicts an exemplary reference hand model 10. The reference hand model 10 may be defined using a hierarchical structure with joints (predefined points) 41, 42, 43, 44, which are linked with connections 50. This joint structure resembles the bone structure of an actual hand, wherein the joints 41, 42, 43, 44 identify positions of joints of a user's hand and the connections 50 may be associated with the bones connecting the joints. In addition, one or more markers may be associated with the tip of the fingers, the tip of the thumb or other positions related to a joint of an actual user hand. One special marker may be associated with the wrist or wrist joint from which five connections 50 are directed towards the fingers and the thumb. Another connection may be associated with the arm of the user. Furthermore, such joint structure may be supplemented with a mesh structure of surfaces resembling the skin of a user. Each joint 41, 42, 43, 44 of the reference model 10 may be rotated using, for example, a rotational matrix or a quaternion. Optionally, the joints may also be translated which may reflect complex motions of human joints, such as a movement of a shoulder. Each transformation of a joint, as defined by its rotation and/or translation, may be directly reflected on subsequent joints of the hierarchical structure. For example, a rotation of joint 44 may influence a position and orientation of joints 41, 42 and 43 of the reference hand model 10. The transformation of each joint may be defined in a local coordinate system with regard to a transformation of a parent joint.

The transformation of individual joints 41, 42, 43, and 44 of the reference hand model 10 may also affect the mesh structure, which may be transformed to reflect the transformation of the individual joints of the reference hand model 10.

Even though the reference hand model 10 in FIG. 2 may be shown as comprising connections 50, it is to be understood that the connections 50 may also be defined as offsets in the local coordinate system of each joint 41, 42, 43, 44. For example, the position of joint 43 may be defined as an offset or translation in the local coordinate system of joint 44. Hence, connections 50 may be regarded as a predefined transformation within a local coordinate system. Both the transformation of the joints 41, 42, 43, 44 and the offsets may be adjusted during mapping of the reference model 10 to the initial image of the user to produce a mapped reference model, which may reflect the anatomy of the user.

The depicted reference hand model 10 may comprise a predetermined size and shape without any direct correlation with a particular hand of a user. The corresponding natural variations may cause problems in correctly recognizing the gestures and, according to the present disclosure, a mapping is used to improve the recognition, or at least speed up the recognition.

When mapping the reference hand model to the at least one image of the user's hand, the shape or structure of the reference hand model may be adapted to the actual user's hand. For example, this may involve an adjustment with respect to the sizes or length of the connections 50 or the positions of the markers 41, 42, 43, 44 taking into account that hands or fingers of different users may differ in size, length, thickness, or shape. The mapping defines thus a correlation or connection between the (uniquely defined) reference hand model and the actual user's hand (i.e., its concrete shape or size) so that the mapping can be used to adjust the reference hand model to the actual user's hand. The mapping may also be used to transform a captured image of the actual user's hand (or a gesture) to the reference hand model (or a gesture thereof). As a result, a gesture of the user's hand can be compared with the pre-stored or predefined gestures.

Therefore, there are at least two possibilities: (i) the predefined gestures are modified or adapted to the particular user's hand and subsequently stored as personalized gestures, or (ii) the mapping itself (an adaption of transformations and offsets of the joints) is stored so that a user's hand (or a user gesture) can be mapped on the reference hand model (or set of predefined gestures). For both cases, this improves the recognition of gestures, because peculiarities of each user are taken into account.

The system may automatically identify a captured hand (e.g., by a predefined identification gesture) as a hand of the particular user and use the corresponding mapping or personalized gestures of the identified user, thereby improving the recognition of the gestures of the user (after the identification).

Although humans are typically able to identify correctly gestures already from 2D captured images, computer devices have often problems in correctly interpreting the captured gestures. The gesture recognition can be significantly improved if the gestures are defined based on a 3D model. In a 3D model, a visual picture is not only defined by two coordinates (spanning the picture plane), but also by depth information defining a third coordinate that is independent of the other two coordinates. Consequently, objects in a 3D image include more information suitable to distinguish parts of a captured image belonging to a human body from the image background. Therefore, the three-dimensional image is advantageous in that it allows taking into consideration not only the particular planar size of the user's hand, but also the actual three-dimensional shape of the user's hand.

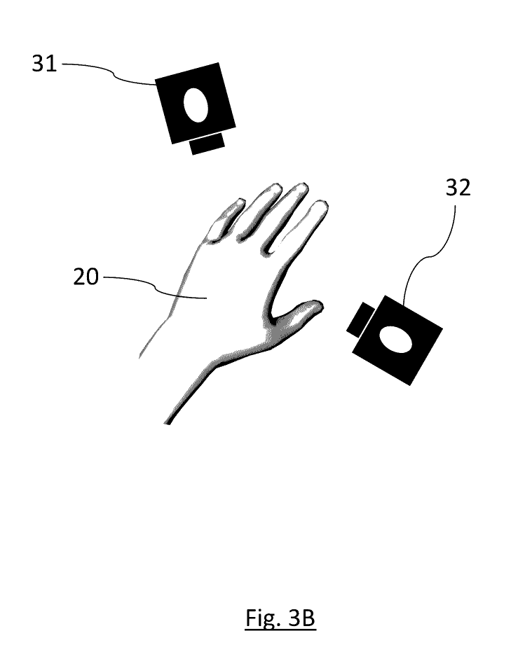

There are at least two possible ways to capture a three-dimensional image of the user's hand. One way is to capture the user's hand using a 3D camera (a depth camera or a stereoscopic camera) as it is depicted in FIG. 3A showing a depth image of the user's hand 20. Another possibility (see FIG. 3B) is to capture the user's hand 20 by two cameras, a first camera 31 and a second camera 32, wherein each of the two cameras 31, 32 is able to capture a 2D image of the user's hand from different perspectives. For example, the first camera 31 can capture the user's hand 20 from a left side, whereas the second camera 32 captures the user's hand 20 from the right side. Having the two separate two-dimensional images, the system can generate one 3D image of the user's hand 20. Both cameras may also be aligned in that they capture images in the same viewing direction as an exemplary user. The two cameras 31, 32 may or may not be aligned within a plane defined by the palm of the user's hand 20.

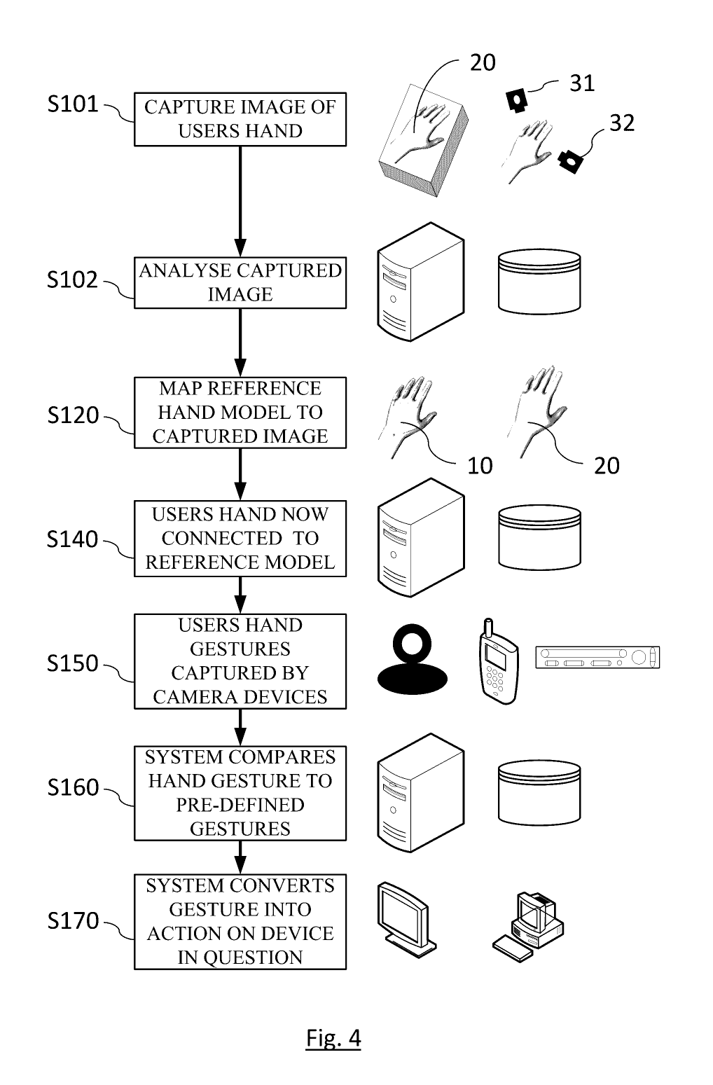

FIG. 4 depicts an exemplary flowchart for a method implemented in a system in accordance with the present disclosure. In a first step S101, the user's hand is captured, either by a 3D camera or by two 2D cameras 31, 32. Next, at step S102, the system analyzes the captured image. The analyzing may include identifying the palm of the hand and/or the position and direction of each finger, the thumb, and of the arm. The analysis is, for example, suitable to identify the joints 41, 42, 43, 44 and/or markers of the reference hand model (see FIG. 2) within the image captured in the first step S101.

At step S120, the system maps the reference hand model 10 to the captured image of the actual hand 20. This mapping may involve finding the positions of the joints 41, 42, 43, 44 in the actual hand and their relative position to each other. Therefore, as a result of the mapping, the system is able to modify the reference hand model in that, for example, offsets of the connections 50 are modified or the angles between joints as well as their transformation and offsets are changed and/or adapted to the actual hand of the user. This will also modify the positions of the markers relative to each other.

At step S140, the system has connected the user's hand to the reference hand model. This step may include an assignment of modifications to the particular user. For example, a table may list for each marker a corresponding user-specific correction. It may also involve a modification of the reference hand model itself. After having connected the reference hand model 10 to the actual hand 20, the result can be stored in a storage (locally or remotely) or a memory of the system to be used for identifying the predefined set of gestures.

At step 150, the system may capture a gesture of the user (e.g., with the hand) by the exemplary camera and at step 160, the system may compare the captured gesture with predefined gestures. In this comparison the results of steps 120 and 140 may be used in order to personalize the gesture(s). For example, before comparing the captured gesture with stored predetermined gestures, the system may map the captured gesture using the mapping of step 120 (or its inverse) to derive a mapped captured gesture. This mapped captured gesture is finally compared with the set of predefined gestures to select one gesture.

Finally, at step S170, the system converts the selected gesture into a particular action on the device in question. For example, each gesture of the set of gestures may be associated with a particular action to be performed on the computing device. The action may involve a broad range of actions such as lowering or increasing the volume, control the display or browsing through documents or some other control action to be performed by the computing device.

The described method may be implemented on any kind of processing device. A person of skill in the art would readily recognize that steps of various above-described methods might be performed by programmed computers. Embodiments are also intended to cover program storage devices, e.g., digital data storage media, which are machine or computer readable and encode machine-executable or computer-executable programs of instructions, wherein the instructions perform some or all of the acts of the above-described methods, when executed on the a computer or processor.

The computer may be any processing unit comprising one or more of the following hardware components: a processor, a non-volatile memory for storing the computer program, a data bus for transferring data between the non-volatile memory and the processor and, in addition, input/output interfaces for inputting and outputting data from/into the computer.

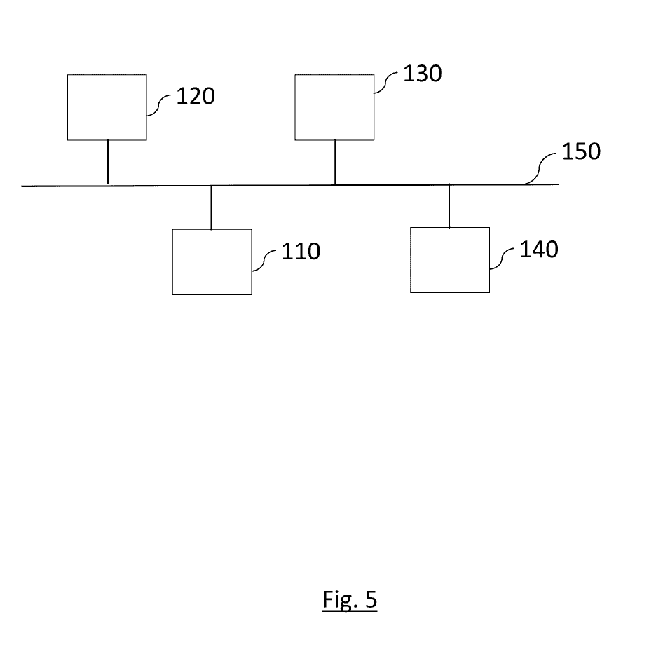

FIG. 5 depicts an apparatus as an example for a processing device for improving gesture recognition based on at least one image of a user. The exemplary apparatus may comprise the following components: a memory 110, a logic 120 (for example one or more processors), an interface 130 for connecting a capturing device and further optional interfaces 140. An exemplary bus 150 may connect these components to transmit data and information between the connected components. The capturing device 130 may, for example, include one or more three-dimensional cameras or two-dimensional cameras and may also be part of the apparatus. The optional interface(s) 140 may include a network interface or further user interfaces for providing input or output from/to the apparatus. The memory 110 may, in particular, be a non-volatile memory as, for example, a hard drive or solid-state drive or a RAM-memory chip.

According to further embodiments, a computer program includes program code for performing one of the above methods, when the computer program is executed on the apparatus (e.g., a computer or processor). A person of skill in the art would readily recognize that steps of various above-described methods might be performed by programmed computers. Herein, some examples are also intended to cover program storage devices, e.g., digital data storage media, which are machine or computer readable and encode machine-executable or computer-executable programs of instructions, wherein the instructions perform some or all of the steps of the above-described methods. The program storage devices may be, e.g., digital memories, magnetic storage media such as magnetic disks and magnetic tapes, hard drives, or optically readable digital data storage media. The examples are also intended to cover computers programmed to perform the steps of the above-described methods or (field) programmable logic arrays ((F)PLAs) or (field) programmable gate arrays ((F)PGAs), programmed to perform the acts of the above-described methods.

Advantageous aspects of the various embodiments can be summarized as follows:

Before attempting gesture recognition, the system may, in a first step, capture an image of the user's hand (for example palm facing down). The capturing may be done using two video cameras or a depth camera based on capturing techniques including depth maps as it is depicted in FIGS. 2 and 3. The purpose of the first step is to capture the user's hand, to analyze its shape by the system, and to create captured hand data used to recognize the user's hand in readiness. In addition, the user's hand may be linked to a skeleton reference hand model 10 that is stored/contained within the system.

Next, a calibration step follows. The skeleton reference hand model 10 consists of a surface mesh and joint structure that represents the bones and joints of each finger and the thumb of a human hand. The model may be identical or similar to the skeleton models used by developers in the creation of animated meshes for avatars or characters in computer games. In this step, key points or markers are set at predefined places or positions on the reference hand model 10. These key points or markers may be, for example, on each fingertip, each knuckle joint and possibly points around the wrist joint, i.e., the vertical (yaw) and lateral (pitch) axes of the wrist.

Once the system has analyzed the captured image of the user's hand it then may map the skeleton reference hand model to the captured hand image. This process connects the user's real hand to the reference model and, in doing so, to a set of predefined gestures that are stored within the database (e.g., a component of the system or of a remote device). This mapping allows the system to cope with many different hand sizes and the inevitable variance in characteristics of each user's hand. As a result, the system is able to cope with a wide range of different users. Optionally, during the recognition process “virtual markers” may be placed on the user's real hand (e.g., using a color pen), which would speed up the data transfer during the hand movements or gestures made.

The predefined 3D hand gestures, while not specifically defined, may comprise a bank of simple to perform gestures such as: thumb and forefinger pinching/un-pinching, or making/unmaking a clenched fist. These predefined motion data (3D hand gestures) are stored in a database, wherein each is connected to a specific instruction such as increasing or lowering the volume of a device. The permutations for what control or instruction or task is carried out and on what particular device are vast. In the example of raising and lowering the volume of a device, a potential 3D hand gesture used could be the forefinger and thumb pinching/unpinching sequence where pinching the finger and thumb together would decrease the volume and the unpinching motion would increase the volume of the device in question.

Furthermore, a person skilled in the art can easily imagine many different possibilities for the capture device such as off-the-shelf equipment as connected cameras, webcams, video cameras, smart devices, etc., which are able to be used to capture the user's 3D hand gestures. In addition, these devices could be connected to the system and in turn to the device via a wireless connection or, when this is not a viable option, a hardwire connection may be applied.

As a result, the present disclosure provides a simple and easy way of improving gesture recognition. For example, the user does not need to teach the computer device all possible gestures. A picture of an exemplary hand or both hands provides enough information for the system to carry out all needed adjustments for the pre-stored gestures to the particular form, shape or size of the user's hand. This can be done automatically without any need of user interaction.

It is understood that functions of various elements shown in the figures may be provided through the use of dedicated hardware, such as “a signal provider,” “a signal processing unit,” “a processor,” “a controller,” etc., as well as hardware capable of executing software in association with appropriate software. Moreover, any entity described herein may correspond to or be implemented as “one or more modules,” “one or more devices,” “one or more units,” etc. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

It should further be understood that within the present disclosure the term “based on” includes all possible dependencies. For example, “a step A being based on feature B” implies only that there are modifications of B that result in modifications of step A. However, there may be other modifications of B that do not result in modifications in step A.

Furthermore, it is intended to include features of a claim to any other independent claim even if this claim is not directly made dependent to the independent claim.

The description and drawings merely illustrate the principles of the disclosure. It will thus be appreciated that those skilled in the art will be able to devise various arrangements that, although not explicitly described or shown herein, embody the principles of the disclosure and are included within its scope.

1. A computer-implemented method for gesture recognition, the method comprising:
providing a reference model defined by a joint structure;
receiving at least one image of a user; and
mapping the reference model to the at least one image of the user, thereby connecting the user to the reference model for recognition of a set of gestures predefined for the reference model, when the gestures are performed by the user.

2. The method according to claim 1, wherein the provided reference model defines a three-dimensional (3D) model of at least a part of a human, including a hierarchical structure of joints.

3. The method according to claim 1, wherein the step of mapping further comprises adjusting relative positions of joints of the reference model, thereby adapting a shape of the reference model to the image of the user.

4. The method according to claim 1, further comprising capturing and providing the at least one image of the user, wherein the at least one image of the user comprises a three-dimensional image or at least two images from different perspectives.

5. The method according to claim 1, further comprising analyzing the at least one image of the user to enable a comparison with the reference model, wherein analyzing comprises identifying joint positions in captured images.

6. The method according to claim 1, wherein the reference model comprises markers at predetermined positions, wherein the markers preferably define points through which at least one rotational axis of a movement passes.

7. The method according to claim 1, further comprising identifying virtual markers placed on the user, wherein the mapping is based on said identified virtual markers.

8. The method according to claim 1, further comprising storing the mapped reference model in a database.

9. The method according to claim 8, further comprising identifying the user based on the mapped reference model.

10. The method according to claim 1, further comprising:
receiving at least one captured image depicting a gesture of the user;
recognizing in the at least one captured image one of the predefined gestures based on results of the mapping; and
initiating a predefined action associated with the recognized gesture.

11. The method according to claim 1, wherein the predefined gestures include at least one of pinching a thumb and a forefinger, unpinching the thumb and the forefinger, making a clenched fist, unmaking a clenched fist.

12. An apparatus for gesture recognition based on at least one image of a user, the apparatus comprising:
a memory configured to store and provide a reference model defined by a joint structure;
an input interface configured to receive at least one image of a user; and
at least one processor configured to map the reference model to the at least one image of the user, thereby connecting the user to the reference model for recognition of a set of gestures predefined for the reference model, when the gestures are performed by the user.

13. The apparatus according to claim 12, wherein the at least one processor is further configured to adjust relative positions of joints of the reference model, thereby adapting a shape of the reference model to the user.

14. The apparatus according to claim 12, wherein the input interface is further configured to connect to an image capturing device for capturing and providing the at least one image of the user, wherein the at least one image of the user comprises a three-dimensional image or at least two images from different perspectives.

15. The apparatus according to claim 14, wherein the image capturing device is configured to capture at least one image depicting a gesture of the user, and the processor is further configured to recognize in the at least one captured image one of the predefined gestures based on results of the mapping, and to initiate a predefined action associated with the recognized gesture.

16. The apparatus according to claim 12, further comprising a comparator configured to compare the at least one image of the user with the reference model to identify joint positions in captured images.

17. The apparatus according to claim 12, wherein the at least one processor is further configured to store the mapped reference model in a database.

18. The apparatus according to claim 17, wherein the at least one processor is further configured to identify the user based on the mapped reference model.

19. A computing device including a capturing device and a processor, wherein the processor is configured to recognize in at least one image captured by the capturing device a predefined gesture based on a mapped reference model, wherein the mapped reference model is generated according to the method of claim 1.

20. A computer-readable medium having instruction stored thereon, wherein the instructions when executed on a computer or a processor cause the computer or processor to perform the method of claim 1.
